(19) United States
(12) Patent Application Publication
(10) Pub. No.: US 2025/0121984 A1
(43) Pub. Date: Apr. 17, 2025

(54) TEXTURED SURFACE FOR BEVERAGE CONTAINERS

(71) Applicant: Canpack S.A., Kraków (PL)

(72) Inventors: Mariusz Maciejowski, Brzesko (PL); Piotr Grech, Brzesko (PL)

(21) Appl. No.: 18/490,140

(22) Filed: Oct. 19, 2023

(30) Foreign Application Priority Data
Oct. 12, 2023 (EP) 23461666.2

(51) Int. Cl. B65D 23/08; B44C 1/20

(52) U.S. Cl. CPC B65D 23/0828; B44C 1/205; B65D 2203/00

(57) ABSTRACT

The subject matter is directed to decorating containers, preferably beverage containers, to create a textured surface, which may include randomly oriented and/or patterned protrusions extending outward from, for example, a can body. The textured effect may be accomplished without the use of lithography to generate randomly oriented and shaped protrusions of various sizes, or may be accomplished using lithography to apply a pattern of inks on the container to form protrusions of predefined shapes and/or sizes. Using the techniques described the decorated can bodies have an increased “textured-feel” than previous textured can bodies. The decorative effect is created using inks that in combination with a varnish antagonistic to the ink result in the generation of protrusions having lateral dimensions greater than 1 mm and/or having heights of between 40 microns and 80 microns.

### CROSS-REFERENCE TO RELATED APPLICATIONS

This application claims priority to European Application No. 23461666.2, filed Oct. 12, 2023, which is hereby incorporated by reference in its entirety for all purposes.

### BACKGROUND OF THE INVENTION

Beverage cans, bottles, and other containers are often formed from plastic, aluminum, or glass. Oftentimes, due to the manufacturing techniques used to produce these containers, the outer surfaces of the containers are slick. The slick outer surfaces may be difficult to securely grasp, especially if condensation has formed on the outer surface of the container. To address these issues, manufacturers sometimes use lithography apply a pattern of inks on the container. In addition, in some situations the end consumer for a beverage container or can may prefer the “textured-feel” on the can, which softens the feel for the plain, usually metal, smooth surface. Furthermore, decorators often use texture to provide unique and different effects at the request of the beverage suppliers.

The inks may include discrete regions of varnish antagonistic ink separated by varnish compatible ink. A varnish is applied over an ink pattern. The varnish then migrates to fill areas of the varnish compatible ink to form a regular pattern of protrusions having heights of about 30-35 microns. These protrusions provide a small amount of improvement to the grip and grip feel of the container, however such containers may still be slick, especially when wet. In addition, there is a need for improving the tactile “textured-feel” of the surface of a beverage container giving a more “spongy” texture. Additionally, the use of lithography complicates the manufacturing process. Therefore, improvements in beverage container surfaces and methods for producing such containers are desired.

### BRIEF SUMMARY OF THE INVENTION

Embodiments of the present invention may encompass beverage containers. The beverage containers may include a container body having an outer surface. The beverage containers may include a textured graphic disposed on a portion of the outer surface. The textured graphic may include a plurality of protrusions that are randomly oriented on the portion of the outer surface. At least some of the plurality of protrusions may have a lateral dimension that is at least 1 mm. At least some of the plurality of protrusions may have a maximum height of between 40 microns and 80 microns relative to a lowest point on the portion of the outer surface. Each of the plurality of protrusions may include an ink and a varnish.

In some embodiments, the ink may exhibit a surface tension of less than about 30 mN/m² when dry. An upper surface of at least some of the plurality of protrusions may include at least one popped air bubble. At least some of the plurality of protrusions may have a lateral dimension that is at least 2 mm. Substantially all of the plurality of protrusions may include irregular shapes. The container body may include a neck. The portion of the outer surface may be disposed below the neck. The portion of the outer surface may extend entirely about a circumference of the outer surface.

Some embodiments of the present technology may encompass methods of applying a texture to a beverage container. The methods may include applying an ink to at least a portion of an outer surface of a beverage container. The methods may include applying a varnish over the ink, which may be wet in some embodiments. The methods may include applying heat to the varnish and the ink to initiate a reaction between the ink and the varnish that causes accumulation of the varnish to form a textured graphic on the outer surface. The textured graphic may include a plurality of protrusions. At least some of the plurality of protrusions may have a lateral dimension that is at least 1 mm. At least some of the plurality of protrusions may have a maximum height of between 40 microns and 80 microns relative to a lowest point on the portion of the outer surface.

In some embodiments, the reaction may be caused by a difference in surface tension between the wet ink and the varnish. The difference in surface tension between the wet ink and the varnish may be at least 20 mN/m². The plurality of protrusions may be randomly oriented about the portion of the outer surface. Applying the ink may include using lithography to apply the ink in a repeating pattern on the portion of the outer surface. The plurality of protrusions may be arranged to fill in voids present in the repeating pattern. The ink may include a varnish antagonistic ink. The voids may include a varnish compatible ink. Applying heat to the varnish and the wet ink may cause air bubbles to form and pop to form dimples in an upper surface of at least some of the plurality of protrusions. Applying heat to the varnish and the wet ink may include exposing the beverage container to a temperature of between 175° C. and 230° C. for between 10 seconds and 60 seconds. The methods may include fully curing the ink and the varnish.

Some embodiments of the present invention may include systems for applying texture to a beverage container. The systems may include a printing device that is configured to apply an ink to at least a portion of an outer surface of a beverage container. The systems may include a coating device that is configured to apply a varnish over the wet ink. The systems may include a heating device that is configured to apply heat to the varnish and the wet ink to initiate a reaction between the wet ink and the varnish that causes accumulation of the varnish to form a textured graphic on the outer surface. The textured graphic may include a plurality of protrusions. At least some of the plurality of protrusions may have a lateral dimension that is at least 1 mm. At least some of the plurality of protrusions may have a maximum height of between 40 microns and 80 microns relative to a lowest point on the portion of the outer surface.

In some embodiments, the heating device may be configured to expose the beverage container to a temperature of between 175° C. and 230° C. for between 10 seconds and 60 seconds. The systems may be configured to apply texture to at least 800 cans per minute. The heating device may include a pin oven.

### BRIEF DESCRIPTION OF THE DRAWINGS

A further understanding of the nature and advantages of the disclosed technology may be realized by reference to the remaining portions of the specification and the drawings.

FIG. 1 illustrates a schematic view of a production line according to embodiments of the present invention.

FIG. 2A illustrates a side elevation view of a beverage can according to embodiments of the present invention.

FIG. 2B illustrates a side elevation view of a beverage can according to embodiments of the present invention.

FIG. 2C illustrates a side elevation view of a beverage can according to embodiments of the present invention.

FIG. 2D illustrates a view of a textured graphic produced using lithography techniques according to embodiments of the present invention.

FIG. 2E illustrates a view of a textured graphic produced without lithography techniques according to embodiments of the present invention.

FIG. 2F illustrates a view of a textured graphic produced without lithography techniques according to embodiments of the present invention.

FIG. 2G illustrates a view of a textured graphic produced without lithography techniques according to embodiments of the present invention.

FIG. 3 illustrates a schematic view of a system for creating textured graphics according to embodiments of the present invention.

FIG. 4 illustrates a flowchart of a process for creating textured graphics according to embodiments of the present invention.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The ensuing description provides exemplary embodiments only, and is not intended to limit the scope, applicability, or configuration of the disclosure. Rather, the description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Embodiments of the present invention are directed to systems and methods for manufacturing product containers (e.g., food and/or beverage cans, bottles, and the like) that include textured surfaces that improve the ease of securely gripping of the containers. For example, the containers described herein may include textures formed by protrusions that have larger footprints and greater heights than textures used on conventional product packages. For example, substantially all of the protrusions may have at least one lateral dimension that is greater than 1 mm and maximum heights of between 40 microns and 60 microns. In some embodiments, some of the protrusions may include dimples or other features (which may or may not have relatively pointed edges) formed along an upper surface of the protrusions. Such dimples may be formed, for example, by carefully controlling a drying time and/or temperature, air bubbles may form that subsequently burst to form the dimples or other features.

The textured graphics in accordance with the present invention may be produced by applying varnish antagonistic ink (and possibly varnish compatible ink) to a surface of the container. The ink may be wet or partially cured, and a varnish may be applied atop the ink. The varnish and the ink may have different surface tensions. The varnish and ink may be exposed to heat, which may cause the varnish to agglomerate in random patterns, forming protrusions across the outer surface of the container. The textured graphics described herein may be produced without the use of lithography, which may simplify the manufacturing process. However, the use of lithography to apply one or more inks in patterns (which may be repeating patterns in some embodiments) may be utilized to further enhance the texture.

While described primarily in the context of beverage cans, it will be appreciated that the systems and methods described herein may be utilized in other container manufacturing processes, especially those in which a texture needs to be applied to a relatively smooth surface. Additionally, the techniques described herein are not limited to aluminum beverage cans and may be utilized in other applications (such as other canning operations, bottling operations, and/or other operations in which a specific package is filled with a particular object and/or substance) and/or with other materials, such as other metals, glass, and/or plastic materials.

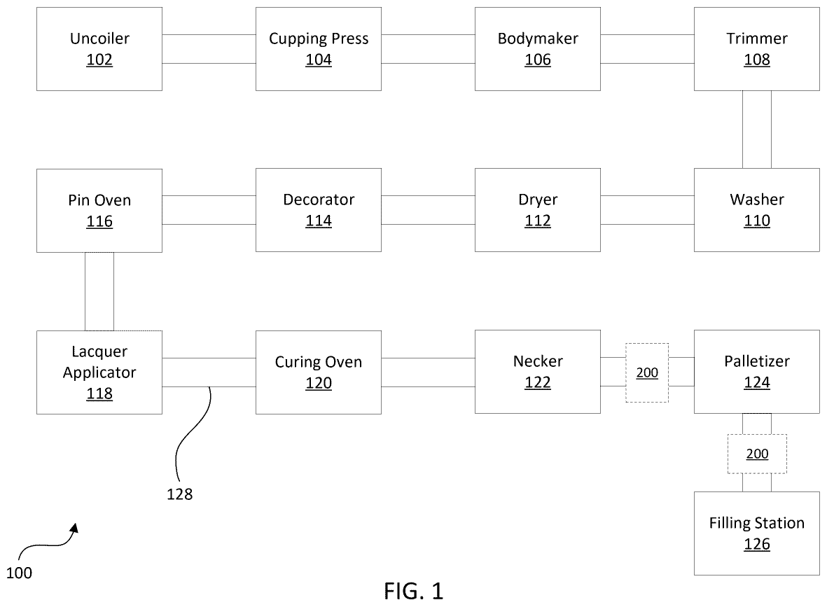

FIG. 1 illustrates a schematic view of a production line 100 for producing beverage cans, such as aluminum cans. Production line 100 will be described as including a number of different devices and is merely representative of one example of a production line. It will be appreciated that numerous variations may exist and that functionality described in relation to one or more devices may be combined and performed by a single device in some embodiments, while in other embodiments functionality attributed to a single device may be performed by a number of distinct devices. Additionally, some embodiments may include additional steps and/or omit one or more steps. Production line 100 may include an uncoiler 102 that lubricates sheet metal and feeds the lubricated sheet metal into a cupping press 104. The cupping press 104 may include a punch that punches out disc-shaped blanks from the sheet metal and subsequently forms the blanks into cup-shapes. For example, the flat disc-shaped blanks may be positioned between a drawing die and a blank holder. The drawing die may define a receptacle that is sized to be larger than a final diameter of the finished can. A punch may press a portion of the blank into the receptacle such that the blank is transformed into a cup-shape.

The cup-shaped blank may be transported to a bodymaker 106, which may form a general shape of the can. For example, the bodymaker 106 may position each cup-shaped blank over a re-drawing die, which may have a diameter that approximately matches a diameter of the finished can. A punch may press the cup-shaped blank through the re-drawing die, which increases the height of the blank while reducing a diameter of the blank to be approximately equal to that of the finished can. After re-drawing the blank, a number of ironing stages may be performed on each blank. For example, in some embodiments each can blank may be passed through three or more ironing stages. At each ironing stage, the blank may be positioned over an ironing die that defines a central aperture, with each successive ironing stage having an ironing die that has an inner diameter that is slightly smaller than the outer diameter of the can blank. At each stage, a punch may press the can blank through the ironing die, which causes the can blank to be stretched vertically, while keeping an inner diameter of the blank unchanged. The ironing process may be repeated any number of times until the can blank has a height that is greater than a final height of the finished can. Oftentimes, during the drawing, re-drawing, and/or ironing process, the bodymaker 106 may spray or otherwise supply a lubricating fluid to the can blank to lubricate and cool the can blank during formation of the can body. After ironing, the blank may be domed. For example, the can blank may be positioned over a doming tool that has a convex dome-shaped surface. A punch having a concave lower surface may press a bottom surface of the blank against the doming tool to form a dome-shaped indentation on the bottom of the blank. After the dome-shaped indention is formed, the blank may be transported to a trimmer 108. The trimmer 108 may trim and/or otherwise remove a top end of the blank such that the top end of the blank has a straight top edge and such that the can blank has a desired height.

After trimming, the blanks may be transported to a washer 110. A number of washing and/or etching operations may be performed on each blank to wash away lubricants from the bodymaker 106 and/or to prepare the surface of the can blank for printing. For example, in some embodiments, a six-stage cleaning process may be performed. In some embodiments, each can blank may be sprayed with two stages of an acid wash. For example, the acidic wash may include sulfuric acid (such as 30% to 40% molar H₂SO₄) and/or other acid-based cleaning agents, which may etch and/or otherwise remove a thin layer of material from the surface of the can blank. Additional cleaning solutions may include, without limitation, Ridoline 740E, Ridoline 120SNF, Bonderite 404S, and/or Bonderite 77 produced by Henkel of Düsseldorf, Germany.

A number of water washes may be performed on each can blank after the acid wash stages. For example, deionized water may be sprayed and/or otherwise applied to the can blank to rinse away the other cleaning solutions. After washing, the can blanks may be transported to a dryer 112. The dryer 112 may include an oven, air jet, and/or other drying mechanism that may dry the can blanks prior to applying any decoration to the can blank.

The dried can blanks may be transported to a decorator 114, which may apply a decoration (such as a brand name, product name, nutrition information, etc.) to an outer surface of the can blank. The decorator 114 may apply any decoration to the outer surface of the can blank in one or more steps. For example, the decorator 114 may be an 8-color offset machine (or other number of colors) that may apply ink to the outer surface of the can blank using a rotation printing process to generate a desired decoration. After printing the decoration, the decorator 114 may apply an overprint varnish to the ink. A bottom of the can may be rim-coated, which may help facilitate rotation and/or other movement of the can blank along the production line. The decorated can blanks may be cured and/or partially cured within a pin oven 116 to harden the ink and varnish.

The cured can blanks may be transported to a lacquer applicator 118. The lacquer applicator 118 may apply a food-grade lacquer to an interior surface of each can blank. This lacquer may help ensure that the final beverage and metal do not contact and/or react with one another. For example, the lacquer may prevent a beverage from eating through the metal, and may also prevent materials from the metal from leeching into and/or reacting with the beverage. The lacquer may be dried within a curing oven 120, which may be a pin oven in some embodiments.

The can blanks may then be transported to a necker 122. The necker 122 may shape a top end of the can blank to form a neck. For example, a number of necking stages may gradually narrow the top end of the can blank to form the neck. Each necking stage may include an inner die that is inserted within the can blank and a necking die that is positioned outside the can blank. In each stage, the necking die has a slightly smaller inner diameter so as to slightly bend the top of the can inward to form the neck. In some instances, as many as 11 necking stages may be used to form the neck. Once the neck is formed, a top edge of the neck may be curved over to form a flange that may later be used in sealing the can. After the neck has been flanged, the cans may be transported to a palletizer 124, which may arrange the cans on pallets for transport to a filling facility and/or station 126.

The filling station 126 may be in a same facility as the rest of the production line 100 and/or may be located in a remote facility. For example, a manufacturer of the cans may provide the palletized cans to a bottler, which may fill and seal the cans for shipment to customers. At the filling station 126, each can may be filled with a beverage (or other substance) that corresponds to the decoration and/or other identifier (such as a barcode) that is printed on the can. After the cans are filled, a top, such as a lid having a stay-on tab, may be affixed to the flanged neck of the can. For example, edges of the lid and flanged neck may be crimped together, oftentimes with a sealant disposed therebetween to help seal the can. Prior to and/or during filling, the liquid may be pasteurized to kill bacteria within the can. This process may involve heating the liquid up to a temperature of at least 63° C. in some embodiments. In some embodiments, the pasteurization may include heating the liquid prior to dispensing the liquid into the cans. In other embodiments, once filled, the cans may be heated within a pasteurization oven to heat the liquid inside the cans to the necessary temperature. For example, heated water (such as water at 65° C.-95° C.) may be sprayed on the filled cans, at least partially submerged in heated water, and/or placed in an over to heat the contents of the can. After the cans have reached the necessary temperature, the cans may be cooled prior to palletization, such as by spraying the cans with cool water. This cooling may help prevent the formation of condensation on the outside of the cans, which may damage cardboard used in the palletization/packing process.

Transportation of the cans/blanks between the various devices may be performed by different conveyor mechanisms 128 throughout the manufacturing process. The mechanism chosen for a given stage may depend on a number of lines of cans entering and/or exiting a given device, a desired throughput, a desired orientation of the cans entering and/or exiting a given device, a current state of the cans entering and/or exiting a given device, and/or other factors. Possible conveyor mechanisms may include conveyor belts, vacuum conveyors (such as vacuum bridges), chain conveyors, roller conveyors, chute conveyors, vertical conveyors, wheel conveyors, pneumatic conveyors, and/or other conveyor mechanisms.

The production line 100 may include any number of quality control stations (not shown) positioned at one or more locations along the production line 100. The quality control stations may check for defects within the cans and ensure that each can meets a required quality control standard. The quality control stations may include one or more sensors (such as imaging sensors, scales, coating thickness gauges, enamel raters, tension meters, and the like) that may be used to determine whether individual cans meet the quality control standards. For example, the sensors may detect a wall thickness of the cans, a dome depth, can weight, proper diameters of the cans, a can height, presence of varnish and/or lacquer, quality of decoration (possibly including a barcode and/or other identifier), presence of a bottom rim coating, packaging quality, and the like. The quality control stations may be positioned after a given operation (e.g., checking a thickness of varnish and/or lacquer immediately after application/curing) and/or may be positioned at a later stage of the production line 100. For example, in some embodiments one or more quality control stations may be positioned just prior to the palletizer 124, such that the sensors may detect any defects that have occurred during production prior to the cans being loaded onto a pallet for shipment to a customer and/or filling. Similarly, one or more quality control stations may be positioned along the filling station 126 to ensure that the cans meet quality control standards prior to, during, and/or after filling of the can.

Production line 100 may include one or more removal mechanisms (not shown) that may be positioned at one or more points along the production line 100. The removal mechanisms may be used to remove defective and/or otherwise imperfect cans from the production line 100. For example, if one of the quality control stations determines that a given can or group of cans does not meet a predetermined quality control standard, a removal mechanism may remove the can or group of cans from the production line 100. In some instances, only those cans that have been determined to not meet quality control standard may be removed, while in other embodiments a section of cans proximate the defective can or cans may also be removed. The removal of cans proximate a defective can may be particularly useful in some instances. For example, cans that are improperly oriented on a piece of equipment may lead to collateral damage to nearby otherwise good cans. The removal mechanisms may take many forms, such as air guns, vacuum bridges, mechanical arms, magnetic rejection system (for packaging materials that are ferromagnetic), and/or other known removal mechanisms.

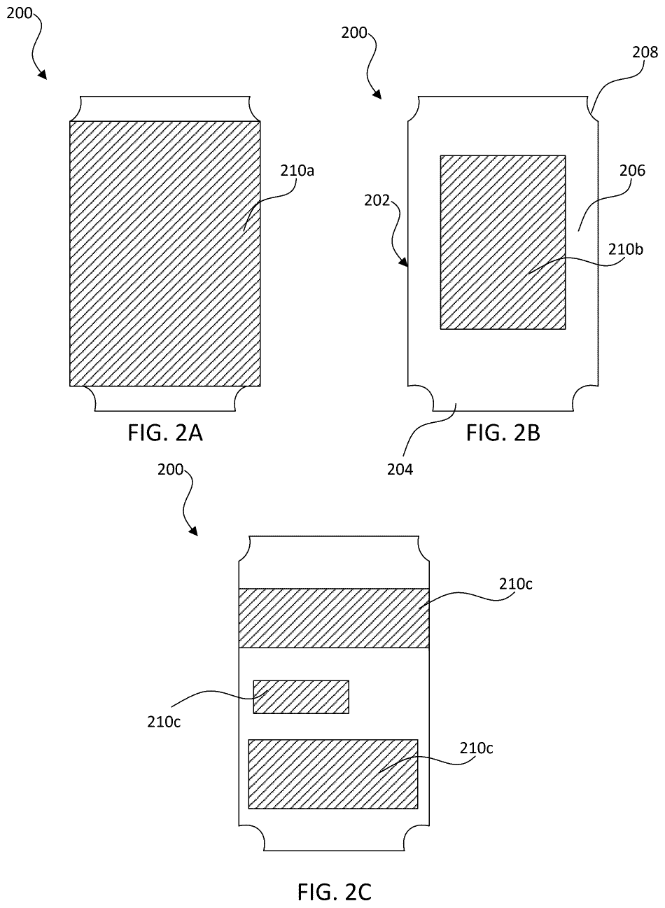

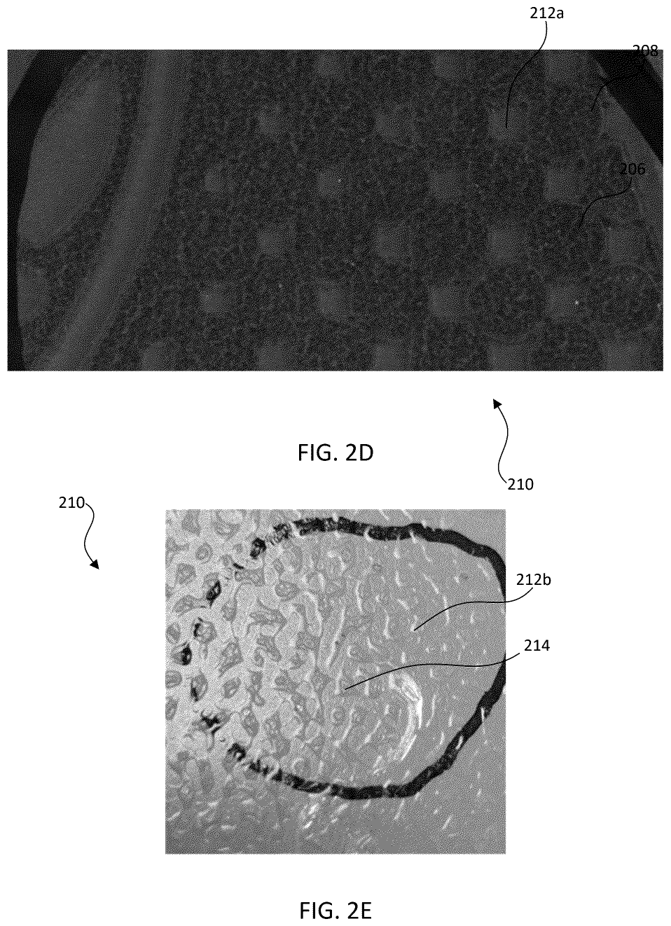

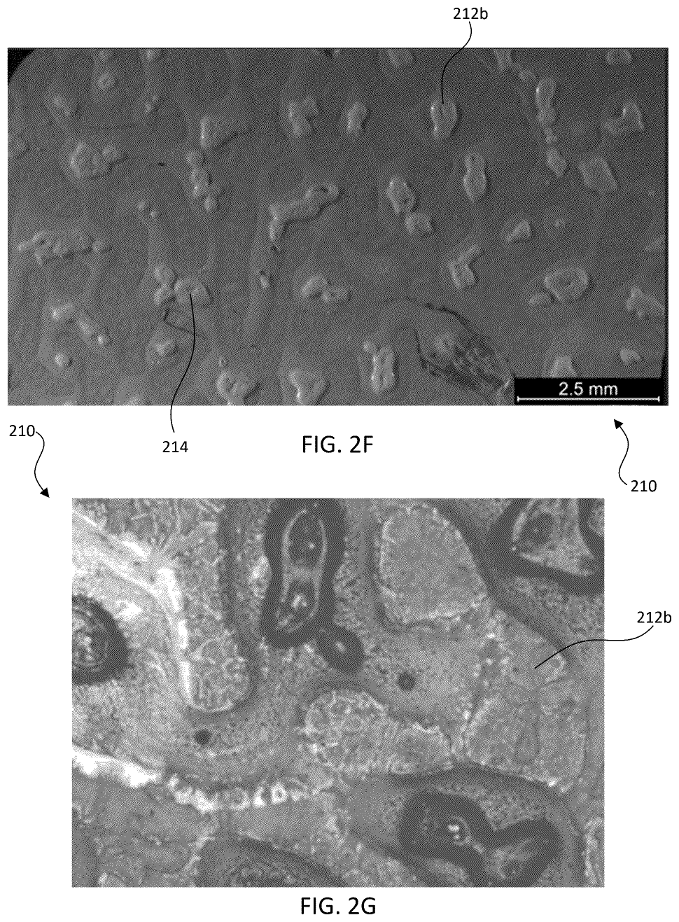

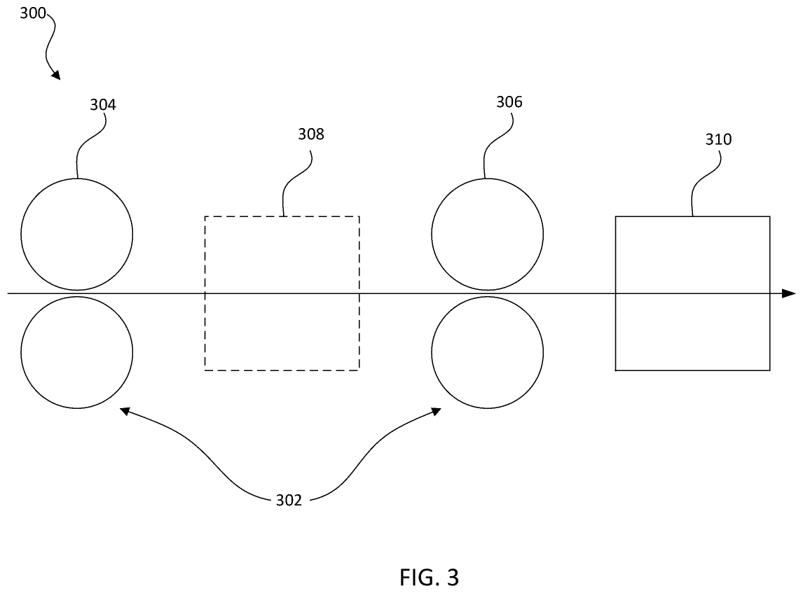

FIGS. 2A-2G illustrate one example of a container 200 having a textured surface in accordance with the present invention. As illustrated, container 200 is an aluminum can, however in other embodiments container 200 may be a glass bottle, plastic bottle, and/or other form of beverage container. Container 200 may include a container body 202 having a base 204, a generally cylindrical sidewall 206, and a neck 208. In some embodiments, a top may be affixed to a top end of neck 208 and may include a tab for opening the top. Container 200 may take other forms in various embodiments. A portion of the outer surface of container 200 may include one or more textured graphics 210. For example, textured graphic 210 may extend about all or a portion of sidewall 206 in some embodiments. As illustrated in FIG. 2A, textured graphic 210a covers substantially all of sidewall 206 (e.g., is not present on neck 208 and/or base 204). In FIG. 2B, textured graphic 210b extends partially about a circumference of sidewall 206 and partially about a height of sidewall 206. In FIG. 2C, textured graphic 210c includes multiple distinct portions that are spaced apart from one another. The portion of textured graphic 210c may be the same and/or different shape and/or size and may be positioned at similar or different rotational and/or height positions on container 200. While shown with three portions, it will be appreciated that textured graphic 210c may include any number of portions. For example, textured graphic 210c may include one or more portions, two or more portions, three or more portions, four or more portions, five or more portions, ten or more portions, twenty or more portions, 50 or more portions, or greater.

Textured graphic 210 may cover any percentage of the outer surface of sidewall 206 (and possibly some or all of neck 208 and/or base 204). For example, textured surface 210 may cover between 5% and 90% of the outer surface of sidewall 206, oftentimes between 25% and 90%, and more commonly between 50% and 90% of the outer surface of sidewall 206. Textured graphic 210 and/or each portion thereof may extend along between 5% and 100% of a height of sidewall 206 and/or between 5% and 100% of a circumference of sidewall 206. In some embodiments, a portion of sidewall 206 may include a textured graphic 210, while other regions of sidewall 206 may include a smooth surface (e.g., no applied texture) and/or areas of less aggressive textures (e.g., textures applied using conventional techniques in which the protrusions have lateral dimensions that do not exceed 1 mm and heights that do not exceed 35 microns). For example, areas of sidewall 206 that are likely to be grasped by a user may include one or more textured graphics 210, while other areas of sidewall 206 have no texture or conventional textured graphics.

In some embodiments, some or all of textured graphic 210 may form all or a part of a logo, graphic, text, and/or other aesthetic design of container 200. For example, textured graphic 210 may be formed from one or more inks (at least some of which may be pigmented) that form all or part of the aesthetic design of container 200 and one or more varnishes that overlay and protect the ink. In other embodiments, some or all of textured graphic 210 may be formed from clear ink and/or varnish, with textured graphic 210 being overlaid atop a preexisting graphic.

As illustrated in FIGS. 2D-2G, textured graphic 210 may include a number of protrusions 212 that extend radially outward from the outer surface of container. As will be discussed in greater detail below, depending on the formation process used, protrusions 212 may arranged in different patterns and/or shapes. For example, as shown in FIG. 2D, protrusions 212a may be arranged in repeating patterns of predefined and/or random/irregular shapes about the outer surface. The predefined shapes may include circles, rectangles, logos, images, numbers, letters, other polygons, and/or other shapes that are defined using a lithographic mask. For example, a pattern of predefined shapes and predefined voids between the shapes may be applied using multiple inks. The predefined shapes may be applied using varnish-antagonistic ink and the voids may be applied using varnish-compatible ink. As will be discussed further below, during production of protrusions 212a, varnish applied to the ink may flow away from the varnish-antagonistic ink present in the predefined shapes and collect within the voids to form protrusions 212a having predefined shapes matching shapes of the voids in the lithographic mask. Typically, in such embodiments, the pattern of shapes and voids is regular such that repeating pattern of protrusions 212a is created, with consistent spacing between protrusions 212a. As shown in FIGS. 2E-2G, protrusions 212b may be randomly oriented with random/irregular shapes about the outer surface. The random/irregular shapes may be formed as a result of the manufacturing process of protrusions 212b and may have any number of curves (e.g., concave and/or convex regions) and variable lateral dimensions taken across different angular positions of a given protrusion 212b. In such embodiments, distances and directions between adjacent protrusions 212b may be entirely random such that no two containers 200 have a same layout of protrusions 212b. In some instances, no two protrusions 212b on container 200 may have a same shape or size. At least 50%, at least 75%, at least 90%, or greater of all protrusions 212b on a given container 200 may be unique in some embodiments.

Some or all protrusions 212 (e.g., at least 75% of protrusions 212, at least 80% of protrusions 212, at least 85% of protrusions 212, at least 90% of protrusions 212, at least 95% of protrusions 212, or more) may have at least one lateral dimension that is at least 1 mm, at least 1.1 mm, at least 1.2 mm, at least 1.25 mm, at least 1.5 mm, at least 1.75 mm, at least 2 mm, at least 2.25 mm, at least 2.5 mm, at least 3 mm, or larger, such as up to 5 mm. Such protrusions 212 are larger than those in conventional textures, which typically have no lateral dimensions that reach 1 mm. Some or all protrusions 212 (e.g., at least 75% of protrusions 212, at least 80% of protrusions 212, at least 85% of protrusions 212, at least 90% of protrusions 212, at least 95% of protrusions 212, or more) may have maximum heights (relative to a lowest point on textured graphic 210) of between 40 microns and 80 microns. For example, some or all protrusions 212 may have maximum heights of at least 40 microns, at least 45 microns, at least 50 microns, at least 55 microns, at least 60 microns, at least 70 microns, at least 80 microns, at least 100 microns, at least 125 microns, at least 150 microns, or greater. Such protrusions 212 are larger than those in conventional textures, which typically have no heights that reach 40 microns. The presence of protrusions 212 having greater lateral dimensions and/or greater maximum heights may provide an enhanced grip relative to conventional textures.

In some embodiments, an upper surface of at least some of protrusions 212 may include at least one popped air bubble 214 as shown in FIGS. 2E-2G. Popped air bubbles 214 may be formed, for example, by carefully controlling a drying time and/or temperature during formation of protrusions 212. For example, during formation, air bubbles may form that subsequently burst to form popped air bubbles 214, which may take the form of dimples or other features within upper surfaces of some or all protrusions 212. Popped air bubbles 214 may have microscopically small sharp peaks and/or other edges that feel rough to the touch and that may further enhance the gripability of textured graphic 210 and consequently the “textured feel” of the surface of the beverage can.

Each protrusion 212 may be formed from an agglomeration of varnish atop an ink and may include some amount of ink in some embodiments. The inks used to produce textured pattern 210 may include one or more varnish-compatible inks (e.g., inks on which a varnish may be readily adhered and that do not affect the overlaying varnish) and/or one or more varnish-antagonistic inks (e.g., inks that do not readily receive varnish and that may cause an overlaying varnish to agglomerate to some degree). The varnish-compatible inks used herein may have surface tensions (when dry) that exceed 35 mN/m², which may enable varnishes to adhere to the ink without being affected. In contrast, the varnish-antagonistic inks used herein may have surface tensions (when dry) that are less than 30 mN/m², less than 25 mN/m², less than 20 mN/m², or less. Suitable varnish-antagonistic inks may include, without limitation, INX No Varnish inks, INX NOVAR inks, Sun Chemical SUNDUO inks, and/or Sun Chemical COMET inks. The inks used herein may be clear and/or may include pigments of any color.

The varnishes used to produce protrusions 212 may have higher surface tensions than the inks, and in particular than the varnish-antagonistic inks. For example, the varnishes may have surface tensions (when wet) that are higher than the inks, with larger differences in surface tension between the varnish and the varnish antagonistic inks leading to greater protrusion sizes. The varnishes may have high solids content of between about 34% and 80% solids, and more commonly between 50% and 70% solids. Varnishes having even higher solids contents (e.g., up to 100% solids) may be used in some embodiments. For example, varnishes with solids contents over 80% may be used in conjunction with larger volumes of varnish and/or slower ink and/or varnish application speeds may be used to create larger protrusions, such as protrusions having lateral dimensions that are between about 2.5 mm and 5 mm. Varnishes may also include between about 0% and 30% by weight of one or more solvents and/or between about 0\hat{ }and 60% by weight of water. Suitable varnishes may include, without limitation, Metlac 815675,BPANI/PFASNI 815788, PPG 9319-801, BPANI/PFASNI XG-W7037, and/or Novochem Novoshield 4765.

FIG. 3 illustrates a system 300 for applying texture to a beverage container. System 300 may form part of production line 100 described above and may be used to create textured graphics such as textured graphics 210. System 300 may include a decorator 302, which may be similar to decorator 114. Decorator 302 may receive can blanks (which may be similar to container 200) that include a container body having a base and cylindrical sidewall. Decorator 302 may include at least one printing device 304 and at least one coating device 306. Printing device 304 may include an offset printer (e.g., printer using a number of ink-coated blankets or rollers to perform a rotation printing process to generate a desired decoration), an inkjet printer, and/or other printing apparatus. Printing device 304 may print or otherwise apply one or more inks to at least a portion of an outer surface of the sidewall to apply a decoration (such as a brand name, product name, nutrition information, etc.) to an outer surface of the can blank. Printing device 304 may apply the decoration to the outer surface of the can blank in one or more steps. For example, printing device 304 may apply one or more colors of ink to the outer surface of the can blank. In some embodiments, the colored ink may include varnish-antagonistic ink and/or varnish-compatible ink. For example, one or more varnish-antagonistic inks may be applied to the outer surface of uniformly (e.g., as a layer having a substantially consistent thickness) across the portion of the outer surface. In other embodiments, printing device 304 may apply different inks in a repeating pattern of shapes and voids. The shapes may be applied using varnish-antagonistic ink and the voids may be applied using varnish-compatible ink.

In some embodiments, decorator 302 may optionally include a heating device 308 that is disposed between printing device 304 and coating device 306. Heating device 308 may be operable to partially cure the ink prior to and/or as the container is transported to coating device 306. For example, heating device 308 may be an oven, convection device and/or other heater that is configured to expose the beverage container to a temperature below the curing temperature of the ink of between 130° C. and 160° C. to partially cure the ink. In other embodiments, the ink may be partially cured in a passive manner without heating device 308. For example, airflow about the ink may partially cure the ink as the container is transported from printing device 304 to coating device 306.

Coating device 306 may apply a varnish, such as a clear or matte varnish, preferably antagonistic to the ink, atop the wet or partially cured (e.g., still wet) ink to protect the ink. At typical line speeds the time between a can body being inked to the varnish being applied is in the region of 30-120 milliseconds. During this time the ink will not dry to any significant extent, meaning that the varnish is applied onto the wet ink. Coating device 306 may be a spray coater, a roller coater, an anilox coater, a gravure coater, and/or other type of coater.

System 300 may include a heating device 310 that may be configured to apply heat to the varnish and the ink to initiate a reaction between the ink and the varnish. The reaction may cause accumulation of the varnish to form a textured graphic on the outer surface. The textured graphic may include a number of protrusions, such as protrusions 212. Heating device 310 may include ovens, such as pin ovens (similar to pin oven 116) in some embodiments. In some embodiments, heating device 310 may be configured to expose the beverage container to a temperature of between 175° C. and 230° C. for between 10 seconds and 60 seconds to initiate the reaction and to harden the ink and varnish.

As noted above, the cured can blanks may be transported to a lacquer applicator (similar to lacquer applicator 118), which may apply a food-grade lacquer to an interior surface of each can blank. The lacquer, ink, and varnish may be fully dried and cured within a curing oven, such as curing oven 120. The can blanks may then be transported to a necker (such as necker 122) for shaping a top end of the can blank to form a neck. Oftentimes, the graphic texture is not applied to the neck of the can, as the graphic texture may be damaged during the necking process. Components of system 300 may be sized to handle large amounts of cans, often enabling texturing and/or other processing of at least 1200 cans per minute.

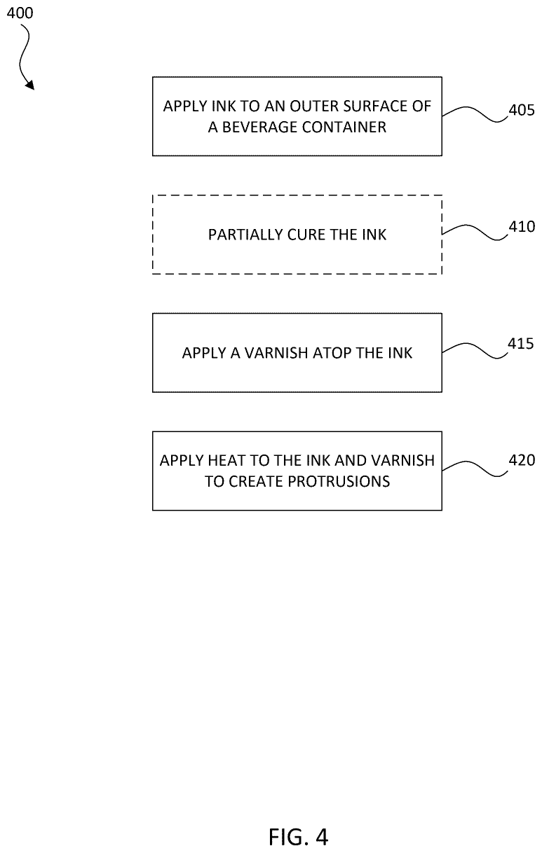

FIG. 4 is a flowchart illustrating a process 400 for applying a texture to a beverage container. Process 400 may be formed using production line 100 and/or system 300 described herein and may be used to create textured graphics such as textured graphics 210. Process 400 may begin at operation 405 by applying one or more inks to at least a portion of an outer surface of a beverage container, such as container 200. The ink may be applied using a printing device, such as printing device 304. The portion of the outer surface on which the ink is applied may include all or a portion of a sidewall of container and may include one or more distinct portions or regions of the outer surface. Typically, the portion of the outer surface on which the ink is applied is limited to the sidewall, with the base and/or neck of the container being devoid of ink, however in some embodiments the ink may be applied to some or all of the neck and/or base. The inks may include clear and/or pigmented inks and, in some embodiments may be applied to create an aesthetic design on the outer surface of the container.

In some embodiments, applying the ink may include applying one or more varnish-antagonistic inks to the portion of the outer surface. The varnish-antagonistic inks may be applied uniformly (e.g., as a layer having a substantially consistent thickness) across the portion of the outer surface. In other embodiments, applying the ink may include applying one or more varnish-antagonistic inks and one or more varnish-compatible inks to the portion of the outer surface using lithography techniques. For example, a lithography mask may be used to apply different inks in a repeating pattern of shapes and voids. The predefined shapes may be applied using varnish-antagonistic ink and the voids may be applied using varnish-compatible ink.

Once the ink is applied, the ink may optionally be partially cured at operation 410. Partially curing the ink may be passive in some embodiments, such as by airflow as the container is moved to a varnish-application device. In other embodiments, partially curing the ink may involve applying heat to the ink using a heating device, such as an oven or other heating device 308. Applying heat may optionally involve exposing the ink to temperatures below the curing temperature of the ink of between 130° C. and 160° C. for a time period of between 0.25 seconds to 5 seconds.

At operation 415, a varnish may be applied over the ink. In other words, the varnish and the ink may both still be in a wet state when the varnish is applied. The varnish may be applied via a coating device such as coating device 306. In some embodiments, the varnish may be applied in a uniform manner across the ink. For example, when the ink includes a uniformly applied varnish-antagonistic ink, the varnish may be applied at a rate of between 6 grams and 15 grams per square meter, with higher rates (possibly with varnishes having higher solids content) being used to generate larger/taller protrusions. Such application rates may result in a varnish layer that is between 5 microns and 15 microns thick. When the ink includes a repeating pattern of varnish-antagonistic ink and varnish-compatible ink, the varnish may be applied at a rate of between 6 grams and 15 grams per square meter, which may result in protrusions having predefined shapes and with maximum heights of at least 40 microns, at least 45 microns, at least 50 microns, at least 55 microns, at least 60 microns, at least 70 microns, at least 80 microns, at least 100 microns, at least 125 microns, at least 150 microns, or greater.

At operation 420, heat may be applied to the varnish and the ink. The heat may be applied via a heating device, such as heating device 310. The application of heat may involve exposing the container to a temperature of between 175° C. and 230° C. for between 10 seconds and 60 seconds, although exposure times exceeding 60 seconds (such as up to 120 seconds 180 seconds, or more) may be used in some embodiments, especially where heating device 310 has a large capacity and/or slow manufacturing speeds are utilized. The heat may initiate a reaction between the ink and the varnish that causes accumulation of the varnish to form a textured graphic on the outer surface. The reaction may be caused by the use of low surface tension inks and the difference in surface tension between the ink and the varnish. In some embodiments, the difference in surface tension between the ink and the varnish may be at least 10 mN/m², at least 15 mN/m², at least 20 mN/m², at least 25 mN/m², at least 30 mN/m², or greater. The textured graphic may be similar to textured graphic 210 and may include a number of protrusions, such as protrusions 212.

When the ink includes a uniformly applied varnish-antagonistic ink, the reaction may result in formation of protrusions that are randomly oriented about the portion of the outer surface of the container. For example, the varnish may agglomerate into random clusters about the varnish-antagonistic ink. Each cluster may have a random shape and/or size, with many or all of the protrusions forming unique irregular shapes. When the ink includes a repeating pattern of varnish-antagonistic ink and varnish-compatible ink, the varnish may flow away from the varnish-antagonistic ink present in the predefined shapes and collect within the voids to form protrusions having predefined shapes matching shapes of the voids in the lithographic mask.

Regardless of how the ink is applied, at least 75% of the resulting protrusions may have at least one lateral dimension that is at least 1 mm and/or at least 75% of the resulting protrusions may have maximum heights of between 40 microns and 80 microns. In some embodiments, the application of the heat to the varnish and the partially cured ink causes air bubbles to form and pop to form dimples in an upper surface of at least some of the protrusions. The dimples may have microscopically small sharp peaks and/or other edges that feel rough to the touch and that may further enhance the gripability of textured graphic and the “textured feel” of the surface of the container.

Once the reaction has occurred, the ink and varnish may be fully cured. For example, heat may be applied in excess of the curing temperature of the ink and varnish (which may be between 188° C. and 230° C.) for a period of at least one minute. Oftentimes, the heat may be applied at a temperature of at least 188° C. for a period of between 2 minutes and 8 minutes and more commonly between 4 minutes and 6 minutes. Process 400 may be performed using equipment that is sufficiently large and operable at high enough speeds to apply textured graphics and/or otherwise process at least 800 cans per minute, at least 1200 cans per minute, oftentimes between about 1200 cans per minute and 2200 cans per minute, with rates of between 1400 cans per minute and 2000 cans per minute, between 1600 cans per minute and 1800 cans per minute, or about 1600 cans per minute being common. In some embodiments, the curing operation may occur after the inside of the container is sprayed with lacquer (and may also cure the lacquer) and prior to necking the container.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention. For example, it is possible to decorate any surface using the ink and varnish combinations of the invention to form the specific height, size and percentage of protrusions, including on a can end or the tab affixed via a rivet to the can end.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as such variations are appropriate to in the context of the systems, devices, circuits, methods, and other implementations described herein.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A beverage container, comprising:
a container body comprising an outer surface; and
a textured graphic disposed on a portion of the outer surface, wherein:
the textured graphic comprises a plurality of protrusions that are randomly oriented on the portion of the outer surface;
at least some of the plurality of protrusions have a lateral dimension that is at least 1 mm;
at least some of the plurality of protrusions have a maximum height of between 40 microns and 80 microns relative to a lowest point on the portion of the outer surface; and
each of the plurality of protrusions comprises an ink and a varnish.

2. The beverage container of claim 1, wherein:
the ink exhibits a surface tension of less than about 30 mN/m² when dry.

3. The beverage container of claim 1, wherein:
an upper surface of at least some of the plurality of protrusions comprises at least one popped air bubble.

4. The beverage container of claim 1, wherein:
at least some of the plurality of protrusions have a lateral dimension that is at least 2 mm.

5. The beverage container of claim 1, wherein:
substantially all of the plurality of protrusions comprise irregular shapes.

6. The beverage container of claim 1, wherein:
the container body comprises a neck; and
the portion of the outer surface is disposed below the neck.

7. The beverage container of claim 1, wherein:
the portion of the outer surface extends entirely about a circumference of the outer surface.

8. A method of applying a texture to a beverage container, comprising:
applying an ink to at least a portion of an outer surface of a beverage container;
applying a varnish over the ink; and
applying heat to the varnish and the ink to initiate a reaction between the ink and the varnish that causes accumulation of the varnish to form a textured graphic on the outer surface, the textured graphic comprising a plurality of protrusions, wherein:
at least some of the plurality of protrusions have a lateral dimension that is at least 1 mm; and
at least some of the plurality of protrusions have a maximum height of between 40 microns and 80 microns relative to a lowest point on the portion of the outer surface.

9. The method of applying a texture to a beverage container of claim 8, wherein:
the reaction is caused by a difference in surface tension between the ink and the varnish.

10. The method of applying a texture to a beverage container of claim 9, wherein:
the difference in surface tension between the ink and the varnish is at least 20 mN/m².

11. The method of applying a texture to a beverage container of claim 8, wherein:
the plurality of protrusions are randomly oriented about the portion of the outer surface.

12. The method of applying a texture to a beverage container of claim 11, wherein:
applying the ink comprises using lithography to apply the ink in a repeating pattern on the portion of the outer surface; and
the plurality of protrusions are arranged to fill in voids present in the repeating pattern.

13. The method of applying a texture to a beverage container of claim 12, wherein:
the ink comprises a varnish antagonistic ink; and
the voids comprise a varnish compatible ink.

14. The method of applying a texture to a beverage container of claim 8, wherein:
applying heat to the varnish and the ink causes air bubbles to form and pop to form dimples in an upper surface of at least some of the plurality of protrusions.

15. The method of applying a texture to a beverage container of claim 8, wherein:
applying heat to the varnish and the ink comprises exposing the beverage container to a temperature of between 175° C. and 230° C. for between 10 seconds and 60seconds.

16. The method of applying a texture to a beverage container of claim 8, further comprising:
fully curing the ink and the varnish.

17. A system for applying texture to a beverage container, comprising:
a printing device that is configured to apply an ink to at least a portion of an outer surface of a beverage container;
a coating device that is configured to apply a varnish over the ink; and
a heating device that is configured to apply heat to the varnish and the ink to initiate a reaction between the ink and the varnish that causes accumulation of the varnish to form a textured graphic on the outer surface, the textured graphic comprising a plurality of protrusions, wherein:
at least some of the plurality of protrusions have a lateral dimension that is at least 1 mm; and
at least some of the plurality of protrusions have a maximum height of between 40 microns and 80 microns relative to a lowest point on the portion of the outer surface.

18. The system for applying texture to a beverage container of claim 17 wherein:
the heating device is configured to expose the beverage container to a temperature of between 175° C. and 230° C. for between 10 seconds and 60 seconds.

19. The system for applying texture to a beverage container of claim 17 wherein:
the system is configured to apply texture to at least 800 cans per minute.

20. The system for applying texture to a beverage container of claim 17 wherein:
the heating device comprises a pin oven.
